(19) United States
(12) Patent Application Publication
(10) Pub. No.: US 2026/0211216 A1
(43) Pub. Date: Jul. 23, 2026

(54) LENS ASSEMBLY

(71) Applicant: Asia Optical Co., Inc., Taichung (TW)

(72) Inventor: Yuan-Chen Chen, Taichung (TW)

(21) Appl. No.: 19/428,460

(22) Filed: Dec. 22, 2025

(30) Foreign Application Priority Data
Jan. 21, 2025 (TW) 114102534

(51) Int. Cl. G02B 13/00; G02B 7/02; G02B 9/64

(52) U.S. Cl. CPC G02B 13/0045; G02B 7/025; G02B 9/64; G02B 13/006

(57) ABSTRACT

A lens assembly includes a first lens, a second lens, a third lens, a fourth lens, a fifth lens, a sixth lens, and a seventh lens, all of which are arranged in order from an object side to an image side along an optical axis. The first lens is with negative refractive power and includes a convex surface facing the object side and a concave surface facing the image side. The second lens is with negative refractive power and includes a convex surface facing the object side and a concave surface facing the image side. The third lens is with refractive power. The fourth lens and the fifth lens are with positive refractive power. The sixth lens is with negative refractive power. The seventh lens is a biconvex lens with positive refractive power and includes a convex surface facing the object side and another convex surface facing the image side.

### BACKGROUND OF THE INVENTION

### Field of the Invention

The present invention relates to a lens assembly.

### Description of the Related Art

The current development trend of a lens assembly is toward large field of view. Additionally, the lens assembly is developed to have high resolution in accordance with different application requirements. However, the known lens assembly can't satisfy such requirements. Therefore, the lens assembly needs a new structure in order to meet the requirements of large field of view and high resolution at the same time.

### BRIEF SUMMARY OF THE INVENTION

The invention provides a lens assembly to solve the above problems. The lens assembly of the invention is provided with characteristics of an increased field of view, an increased resolution, and still has a good optical performance.

The lens assembly in accordance with an exemplary embodiment of the invention includes a first lens, a second lens, a third lens, a fourth lens, a fifth lens, a sixth lens, and a seventh lens. The first lens is with negative refractive power and includes a convex surface facing an object side and a concave surface facing an image side. The second lens is with negative refractive power and includes a convex surface facing the object side and a concave surface facing the image side. The third lens is with refractive power. The fourth lens is with positive refractive power. The fifth lens is with positive refractive power. The sixth lens is with negative refractive power. The seventh lens is a biconvex lens with positive refractive power and includes a convex surface facing the object side and another convex surface facing the image side. The first lens, the second lens, the third lens, the fourth lens, the fifth lens, the sixth lens, and the seventh lens are arranged in order from the object side to the image side along an optical axis. The lens assembly satisfies the following condition: 0.4≤(f5+f6)/f7≤0.6; wherein f5 is an effective focal length of the fifth lens, f6 is an effective focal length of the sixth lens, and f7 is an effective focal length of the seventh lens.

In another exemplary embodiment, the third lens is with positive refractive power.

In yet another exemplary embodiment, the third lens includes a convex surface facing the image side; and the fourth lens includes a convex surface facing the image side.

In another exemplary embodiment, the third lens further includes a convex surface or a concave surface facing the object side.

In yet another exemplary embodiment, the lens assembly further includes a stop disposed between the fourth lens and the fifth lens, wherein the lens assembly satisfies at least one of the following conditions: −2≤(f1+f2)/f3≤−1; 1.4≤(f3+f4)/Max(f3,f4)≤1.9; 0.7≤T3/f3+T4/f4≤1.5; 1.7≤(R51-R52)/R62≤2.1; 30 mm≤(R62×R71)/T67≤40 mm; 8≤(TTL-SL)/f≤15; 3≤(T3+T4)/f≤10; wherein f is an effective focal length of the lens assembly, f1 is an effective focal length of the first lens, f2 is an effective focal length of the second lens, f3 is an effective focal length of the third lens, f4 is an effective focal length of the fourth lens, Max(f3,f4) is a greater value among the effective focal length of the third lens and the fourth lens, T3 is an interval from an object side surface of the third lens to an image side surface of the third lens along the optical axis, T4 is an interval from an object side surface of the fourth lens to an image side surface of the fourth lens along the optical axis, R51 is a radius of curvature of an object side surface of the fifth lens, R52 is a radius of curvature of an image side surface of the fifth lens, R62 is a radius of curvature of an image side surface of the sixth lens, R71 is a radius of curvature of an object side surface of the seventh lens, T67 is an air interval from the image side surface of the sixth lens to the object side surface of the seventh lens along the optical axis, TTL is an interval from an object side surface of the first lens to an image plane along the optical axis, and SL is an interval from the stop to the image plane along the optical axis.

In another exemplary embodiment, the fourth lens further includes a convex surface or a concave surface facing the object side.

In yet another exemplary embodiment, the fifth lens is a biconvex lens and includes a convex surface facing the object side and another convex surface facing the image side.

In another exemplary embodiment, the sixth lens is a biconcave lens and includes a concave surface facing the object side and another concave surface facing the image side.

In yet another exemplary embodiment, the fifth lens and the sixth lens are cemented or there is no air gap between the fifth lens and the sixth lens.

In another exemplary embodiment, the lens assembly further includes a stop disposed between the fourth lens and the fifth lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a first embodiment of the invention;

FIGS. 2, 3 depict a longitudinal aberration diagram, a field curvature diagram, and a distortion diagram of the lens assembly in accordance with the first embodiment of the invention, respectively;

FIG. 4 is a lens layout and optical path diagram of a lens assembly in accordance with a second embodiment of the invention;

FIGS. 5, 6 depict a longitudinal aberration diagram, a field curvature diagram, and a distortion diagram of the lens assembly in accordance with the second embodiment of the invention, respectively;

FIG. 7 is a lens layout and optical path diagram of a lens assembly in accordance with a third embodiment of the invention;

FIGS. 8, 9 depict a longitudinal aberration diagram, a field curvature diagram, and a distortion diagram of the lens assembly in accordance with the third embodiment of the invention, respectively;

FIG. 10 is a lens layout and optical path diagram of a lens assembly in accordance with a fourth embodiment of the invention; and

FIGS. 11, 12 depict a longitudinal aberration diagram, a field curvature diagram, and a distortion diagram of the lens assembly in accordance with the fourth embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, a third lens, a fourth lens, a fifth lens, a sixth lens, and a seventh lens. The first lens is with negative refractive power and includes a convex surface facing an object side and a concave surface facing an image side. The second lens is with negative refractive power and includes a convex surface facing the object side and a concave surface facing the image side. The third lens is with refractive power. The fourth lens is with positive refractive power. The fifth lens is with positive refractive power. The sixth lens is with negative refractive power. The seventh lens is a biconvex lens with positive refractive power and includes a convex surface facing the object side and another convex surface facing the image side. The first lens, the second lens, the third lens, the fourth lens, the fifth lens, the sixth lens, and the seventh lens are arranged in order from the object side to the image side along an optical axis. The lens assembly satisfies the following condition: 0.4≤(f5+f6)/f7≤0.6; wherein f5 is an effective focal length of the fifth lens, f6 is an effective focal length of the sixth lens, and f7 is an effective focal length of the seventh lens. A lens assembly of the present invention can achieve the basic function when the lens assembly satisfies the above features and at least one of the conditions, and does not require other additional features or conditions.

Referring to Table 1, Table 2, Table 4, Table 5, Table 7, Table 8, Table 10, and Table 11, wherein Table 1, Table 4, Table 7, and Table 10 show optical specification in accordance with a first, a second, a third, and a fourth embodiments of the invention, respectively, and Table 2, Table 5, Table 8, and Table 11 show aspheric coefficients of each aspheric lens in Table 1, Table 4, Table 7, and Table 10, respectively.

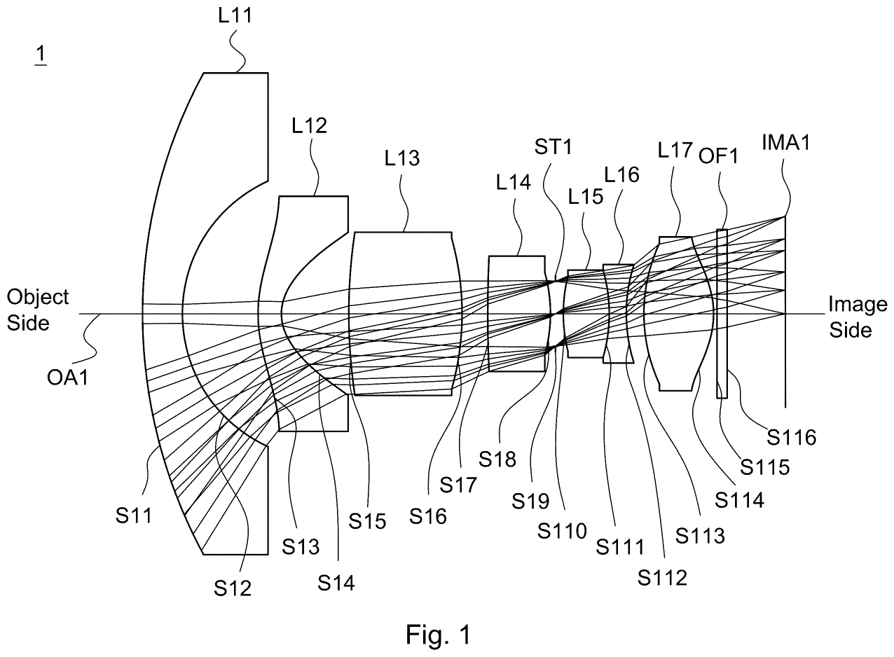

FIGS. 1, 4, 7, and 10 are lens layout and optical path diagrams of the lens assemblies in accordance with the first, second, third, and fourth embodiments of the invention, respectively.

The first lenses L11, L21, L31, L41 are meniscus lenses with negative refractive power and made of glass material, wherein the object side surfaces S11, S21, S31, S41 are convex surfaces, the image side surfaces S12, S22, S32, S42 are concave surfaces, and both of the object side surfaces S11, S21, S31, S41 and image side surfaces S12, S22, S32, S42 are spherical surfaces.

The second lenses L12, L22, L32, L42 are meniscus lenses with negative refractive power and made of glass material, wherein the object side surfaces S13, S23, S33, S43 are convex surfaces, the image side surfaces S14, S24, S34, S44 are concave surfaces, and both of the object side surfaces S13, S23, S33, S43 and image side surfaces S14, S24, S34 are aspheric surfaces.

The third lenses L13, L23, L33, L43 are with positive refractive power and made of glass material, wherein the image side surfaces S16, S26, S36, S46 are convex surfaces.

The fourth lenses L14, L24, L34, L44 are with positive refractive power and made of glass material, wherein the image side surfaces S18, S28, S38, S48 are convex surfaces.

The fifth lenses L15, L25, L35, L45 are biconvex lenses with positive refractive power and made of glass material, wherein the object side surfaces S110, S210, S310, S410 are convex surfaces, the image side surfaces S111, S211, S311, S411 are convex surfaces, and both of the object side surfaces S110, S210, S310, S410 and image side surfaces S111, S211, S311, S411 are spherical surfaces.

The sixth lenses L16, L26, L36, L46 are biconcave lenses with negative refractive power and made of glass material, wherein the object side surfaces S111, S211, S311, S411 are concave surfaces, the image side surfaces S112, S212, S312, S412 are concave surfaces, and both of the object side surfaces S111, S211, S311, S411 and image side surfaces S112, S212, S312, S412 are spherical surfaces.

The fifth lenses L15, L25, L35, L45 and the sixth lenses L16, L26, L36, L46 are cemented and there is no air gap between the fifth lenses L15, L25, L35, L45 and the sixth lenses L16, L26, L36, L46, respectively.

The seventh lenses L17, L27, L37, L47 are biconvex lenses with positive refractive power and made of glass material, wherein the object side surfaces S113, S213, S313, S413 are convex surfaces, the image side surfaces S114, S214, S314, S414 are convex surfaces, and both of the object side surfaces S113, S213, S313, S413 and image side surfaces S114, S214, S314, S414 are aspheric surfaces.

In addition, the wide-angle lens assemblies 1, 2, 3, and 4 satisfy at least one of the following conditions (1)-(8):

$$- 2 \leq ( f 1 + f 2 ) / f 3 \leq - 1 ; \qquad ( 1 )$$

$$1.4 \leq ( f 3 + f 4 ) / Max ( f 3 , f 4 ) \leq 1.9 ; \qquad ( 2 )$$

$$0.7 \leq T 3 / f 3 + T 4 / f 4 \leq 1.5 ; \qquad ( 3 )$$

$$1.7 \leq ( R 51 - R 52 ) / R 62 \leq 2.1 ; \qquad ( 4 )$$

$$30 mm \leq ( R 62 \times R 71 ) / T 67 \leq 40 mm ; \qquad ( 5 )$$

$$0.4 \leq ( f 5 + f 6 ) / f 7 \leq 0.6 ; \qquad ( 6 )$$

$$8 \leq ( TTL - SL ) / f \leq 15 ; \qquad ( 7 )$$

$$3 \leq ( T 3 + T 4 ) / f \leq 10 ; \qquad ( 8 )$$

wherein the parameters in the first to fourth embodiments are defined as follows: f is an effective focal length of the wide-angle lens assemblies 1, 2, 3, 4; f1 is an effective focal length of the first lenses L11, L21, L31, L41; f2 is an effective focal length of the second lenses L12, L22, L32, L42; f3 is an effective focal length of the third lenses L13, L23, L33, L43; f4 is an effective focal length of the fourth lenses L14, L24, L34, L44; f5 is an effective focal length of the fifth lenses L15, L25, L35, L45; f6 is an effective focal length of the sixth lenses L16, L26, L36, L46; f7 is an effective focal length of the seventh lenses L17, L27, L37, L47; Max(f3,f4) is a greater value among the effective focal length of the third lenses L13, L23, L33, L43 and the fourth lenses L14, L24, L34, L44; T3 is an interval from the object side surfaces S15, S25, S35, S45 of the third lenses L13, L23, L33, L43 to the image side surfaces S16, S26, S36, S46 of the third lenses L13, L23, L33, L43 along the optical axes OA1, OA2, OA3, OA4; T4 is an interval from the object side surfaces S17, S27, S37, S47 of the fourth lenses L14, L24, L34, L44 to the image side surfaces S18, S28, S38, S48 of the fourth lenses L14, L24, L34, L44 along the optical axes OA1, OA2, OA3, OA4; R51 is a radius of curvature of the object side surfaces S110, S210, S310, S410 of the fifth lenses L15, L25, L35, L45; R52 is a radius of curvature of the image side surfaces S111, S211, S311, S411 of the fifth lenses L15, L25, L35, L45; R62 is a radius of curvature of the image side surfaces S112, S212, S312, S412 of the sixth lenses L16, L26, L36, L46; R71 is a radius of curvature of the object side surfaces S113, S213, S313, S413 of the seventh lenses L17, L27, L37, L47; T67 is an air interval from the image side surfaces S112, S212, S312, S412 of the sixth lenses L16, L26, L36, L46 to the object side surfaces S113, S213, S313, S413 of the seventh lenses L17, L27, L37, L47 along the optical axes OA1, OA2, OA3, OA4; TTL is an interval from the object side surfaces S11, S21, S31, S41 of the first lenses L11, L21, L31, L41 to the image planes IMA1, IMA2, IMA3, IMA4 along the optical axes OA1, OA2, OA3, OA4; and SL is an interval from the stop ST1, ST2, ST3, ST4 to the image planes IMA1, IMA2, IMA3, IMA4 along the optical axes OA1, OA2, OA3, OA4. Making the lens assemblies 1, 2, 3, and 4 effectively increasing the field of view and effectively correcting aberration.

When the condition (1): −2≤(f1+f2)/f3≤−1 is satisfied, the refractive power can be effectively provided sufficiently so as to effectively increase the resolution and effectively correct the aberration. When the conditions (2), (3): 1.4≤(f3+f4)/Max(f3,f4)≤1.9, 0.7≤T3/f3+T4/f4≤1.5 are satisfied, the light collecting ability can be effectively improved, the resolution can be effectively increased, and the aberration can be effectively corrected. When the conditions (4), (5): 1.7≤(R51-R52)/R62≤2.1, 30 mm≤(R62×R71)/T67≤40 mm are satisfied, the chromatic aberration can be effectively corrected and the resolution can be effectively increased. When the condition (6): 0.4≤(f5+f6)/f7≤0.6 is satisfied, the resolution can be effectively increased and the aberration can be effectively corrected. When the condition (7): 8≤(TTL-SL)/f≤15 is satisfied, the total lens length can be effectively decreased and help to improve the resolution. When the condition (8): 3≤(T3+T4)/f≤10 is satisfied, the light can be effectively collected and enough, the aberration can be effectively corrected, and the resolution can be effectively increased.

A detailed description of a lens assembly in accordance with a first embodiment of the invention is as follows. Referring to FIG. 1, the lens assembly 1 includes a first lens L11, a second lens L12, a third lens L13, a fourth lens L14, a stop ST1, a fifth lens L15, a sixth lens L16, a seventh lens L17, and an optical filter OF1, all of which are arranged in order from an object side to an image side along an optical axis OA1. In operation, the light from the object side is imaged on an image plane IMA1.

According to the foregoing, wherein: the third lens L13 is a biconvex lens, wherein the object side surface S15 is a convex surface and both of the object side surface S15 and image side surface S16 are spherical surfaces; the fourth lens L14 is a biconvex lens, wherein the object side surface S17 is a convex surface and both of the object side surface S17 and image side surface S18 are spherical surfaces; both of the object side surface S115 and image side surface S116 of the optical filter OF1 are plane surfaces; with the above design of the lenses, stop ST1, and at least one of the conditions (1)-(8) satisfied, the lens assembly 1 can have an effective increased resolution and an effective corrected aberration.

Table 1 shows the optical specification of the lens assembly 1 in FIG. 1.

TABLE 1
Effective Focal Length = 1.30 mm F-number = 2.20
Total Lens Length = 19.02 mm Full Field of View = 187.60 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S11 | 14.706 | 1.200 | 1.871 | 40.729 | −7.290 | L11 |
| S12 | 4.292 | 2.237 | | | | |
| S13 | 4.141 | 0.691 | 1.803 | 45.492 | −2.870 | L12 |
| S14 | 1.378 | 1.999 | | | | |
| S15 | 17.266 | 3.340 | 2.001 | 25.458 | 5.833 | L13 |
| S16 | −8.140 | 0.765 | | | | |
| S17 | 50.005 | 1.825 | 1.618 | 63.393 | 7.618 | L14 |
| S18 | −5.159 | 0.165 | | | | |
| S19 | ∞ | 0.232 | | | | ST1 |
| S110 | 4.568 | 1.363 | 1.550 | 75.496 | 4.361 | L15 |
| S111 | −4.568 | 0.500 | 1.808 | 22.764 | −2.790 | L16 |
| S112 | 4.829 | 0.520 | | | | |
| S113 | 4.293 | 2.059 | 1.497 | 82.506 | 3.610 | L17 |
| S114 | −2.613 | 0.100 | | | | |
| S115 | ∞ | 0.300 | 1.517 | 64.167 | | OF1 |
| S116 | ∞ | 1.722 | | | | |

The aspheric surface sag z of each aspheric lens in table 1 can be calculated by the following formula:

$$z = {ch}^{2} / \{ 1 + {[ 1 - ( k + 1 ) {c}^{2} {h}^{2} ]}^{1 / 2} \} + {Ah}^{4} + {Bh}^{6} + {Ch}^{8} ;$$

where c is curvature, h is the vertical distance from the lens surface to the optical axis, k is conic constant and A, B, and C are aspheric coefficients.

In the first embodiment, the conic constant k and the aspheric coefficients A, B, C of each aspheric lens are shown in Table 2.

TABLE 2

| Surface | | | | |
|---|---|---|---|---|
| Number | k | A | B | C |
| S13 | −1.183648 | −0.007769041 | 0.000246 | −4.20419E−06 |
| S14 | −1.045619 | 0.003637402 | −0.0011844 | 4.38976E−05 |
| S113 | 0 | −0.010723528 | 0.0023975 | −0.000188619 |
| S114 | 0 | 0.0171083 | −0.000279293 | 0.0003568 |

Table 3 shows the parameters and condition values for conditions (1)-(8) in accordance with the first embodiment of the invention. It can be seen from Table 3 that the lens assembly 1 of the first embodiment satisfies the conditions (1)-(8).

TABLE 3

| T67 | 0.52 mm | SL | 6.80 mm | T3 | 3.34 mm |
|---|---|---|---|---|---|
| T4 | 1.82 mm | Max(f3, f4) | 7.62 mm | | |
| (f1 + f2)/f3 | −1.74 | (f3 + f4)/Max(f3, f4) | 1.77 | T3/f3 + T4/f4 | 0.81 |
| (R51 − R52)/R62 | 1.89 | (R62 × R71)/T67 | 39.89 mm | (f5 + f6)/f7 | 0.44 |
| (TTL − SL)/f | 9.40 | (T3 + T4)/f | 3.97 | | |

The lens assembly 1 of the first embodiment is a preferred embodiment when it satisfies conditions (1) to (8) as well as the refractive power and surface shape shown in Table 1.

The lens assembly 1 of the first embodiment can also be modified to satisfy any one of the conditions (1) to (8), the first lens is with negative refractive power, the second lens is with negative refractive power, the third lens is with positive refractive power, the fourth lens is with positive refractive power, the fifth lens is a biconvex lens with positive refractive power and includes a convex surface facing the object side and another convex surface facing the image side, the sixth lens includes a concave surface facing the image side, and the seventh lens is with positive refractive power and includes a convex surface facing the object side. The basic function of the lens assembly 1 of the present invention can be achieved without any additional features or conditions.

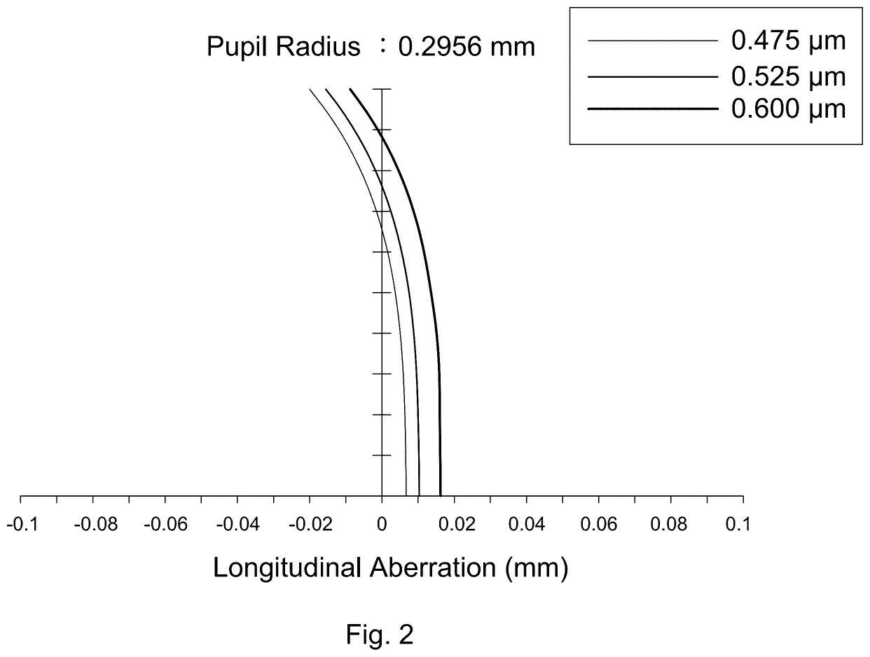

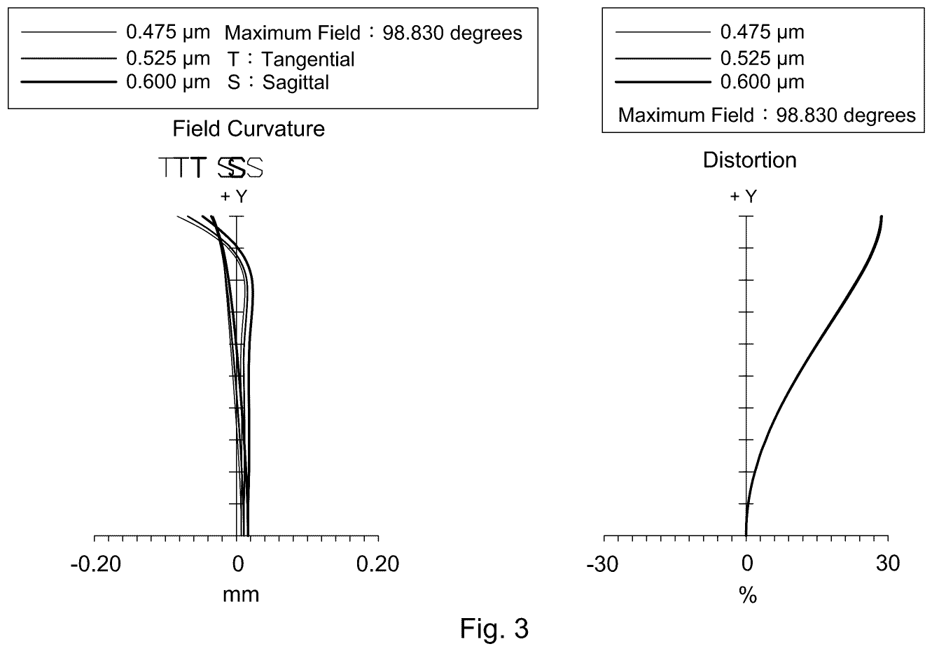

In addition, the lens assembly 1 of the first embodiment can meet the requirements of optical performance as seen in FIGS. 2-3. It can be seen from FIG. 2 that the longitudinal aberration in the lens assembly 1 of the first embodiment ranges from −0.02 mm to 0.02 mm. It can be seen from FIG. 3 that the field curvature of tangential direction and sagittal direction, and the distortion in the lens assembly 1 of the first embodiment ranges from −0.09 mm to 0.03 mm and 0% to 30%. It is obvious that the longitudinal aberration, the field curvature, and the distortion can be corrected effectively for the lens assembly 1 of the first embodiment. Therefore, the lens assembly 1 of the first embodiment is capable of good optical performance.

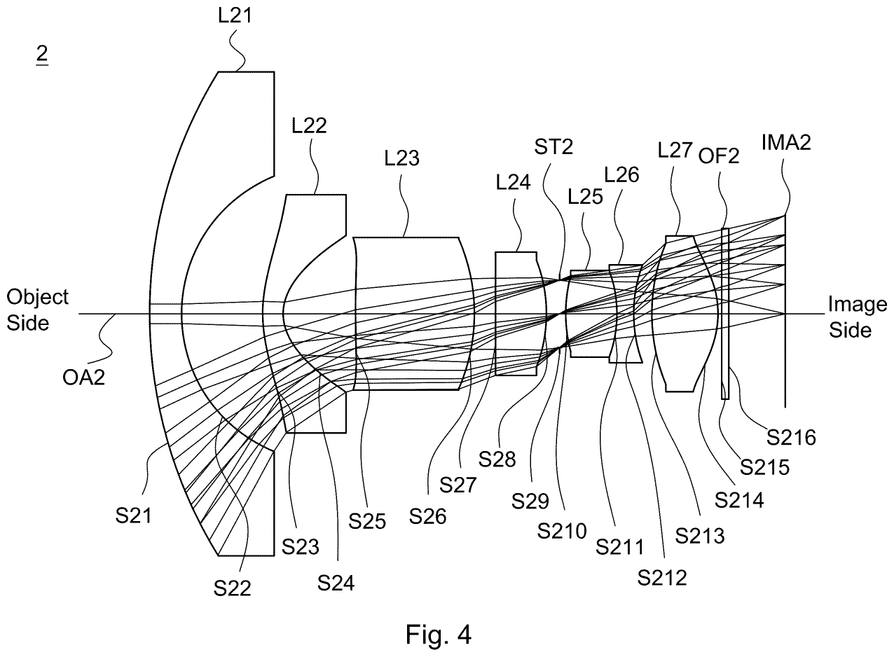

A detailed description of a lens assembly in accordance with a second embodiment of the invention is as follows. Referring to FIG. 4, the lens assembly 2 includes a first lens L21, a second lens L22, a third lens L23, a fourth lens L24, a stop ST2, a fifth lens L25, a sixth lens L26, a seventh lens L27, and an optical filter OF2, all of which are arranged in order from an object side to an image side along an optical axis OA2. In operation, the light from the object side is imaged on an image plane IMA2.

According to the foregoing, wherein: the third lens L23 is a biconvex lens, wherein the object side surface S25 is a convex surface and both of the object side surface S25 and image side surface S26 are aspheric surfaces; the fourth lens L24 is a meniscus lens, wherein the object side surface S27 is a concave surface and both of the object side surface S27 and image side surface S28 are spherical surfaces; both of the object side surface S215 and image side surface S216 of the optical filter OF2 are plane surfaces; with the above design of the lenses, stop ST2, and at least one of the conditions (1)-(8) satisfied, the lens assembly 2 can have an effective increased resolution and an effective corrected aberration.

Table 4 shows the optical specification of the lens assembly 2 in FIG. 4.

TABLE 4
Effective Focal Length = 1.28 mm F-number = 2.20
Total Lens Length = 18.68 mm Full Field of View = 196.50 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S21 | 13.200 | 1.000 | 1.871 | 40.729 | −7.823 | L21 |
| S22 | 4.361 | 2.359 | | | | |
| S23 | 4.300 | 0.600 | 1.774 | 49.590 | −2.896 | L22 |
| S24 | 1.382 | 2.122 | | | | |
| S25 | 25.412 | 3.504 | 1.722 | 29.237 | 6.096 | L23 |
| S26 | −5.097 | 0.616 | | | | |
| S27 | −100.433 | 1.468 | 1.618 | 63.393 | 7.393 | L24 |
| S28 | −4.420 | 0.395 | | | | |
| S29 | ∞ | 0.177 | | | | ST2 |
| S210 | 4.347 | 1.492 | 1.550 | 75.496 | 3.936 | L25 |
| S211 | −3.829 | 0.500 | 1.808 | 22.764 | −2.337 | L26 |
| S212 | 4.079 | 0.523 | | | | |
| S213 | 4.610 | 1.953 | 1.497 | 82.506 | 3.615 | L27 |
| S214 | −2.550 | 0.100 | | | | |
| S215 | ∞ | 0.210 | 1.517 | 64.167 | | OF2 |
| S216 | ∞ | 1.659 | | | | |

The definition of aspheric surface sag z of each aspheric surface in table 4 is the same as that of in Table 1, and is not described here again.

In the second embodiment, the conic constant k and the aspheric coefficients A, B, C of each aspheric surface are shown in Table 5.

TABLE 5

| Surface | | | | |
|---|---|---|---|---|
| Number | k | A | B | C |
| S23 | −2.199551 | −0.005522482 | 0.00018244 | −1.178E−06 |
| S24 | −0.9284968 | −0.002198265 | −0.0003314 | −7.13519E−05 |
| S25 | 0 | −0.00408647 | 5.74849E-05 | −0.0001229 |
| S26 | −0.5685897 | 0.000463617 | −0.000241117 | 4.0101E−05 |
| S213 | 0 | −0.011503855 | 0.00276904 | −0.0002215 |
| S214 | 0 | 0.019018847 | −0.001725085 | 0.00055242 |

Table 6 shows the parameters and condition values for conditions (1)-(8) in accordance with the second embodiment of the invention. It can be seen from Table 6 that the lens assembly 2 of the second embodiment satisfies the conditions (1)-(8).

TABLE 6

| T67 | 0.52 mm | SL | 6.61 mm | T3 | 3.50 mm |
|---|---|---|---|---|---|
| T4 | 1.47 mm | Max(f3, f4) | 7.39 mm | | |
| (f1 + f2)/f3 | −1.76 | (f3 + f4)/Max(f3, f4) | 1.82 | T3/f3 + T4/f4 | 0.77 |
| (R51 − R52)/R62 | 2.00 | (R62 × R71)/T67 | 35.97 mm | (f5 + f6)/f7 | 0.44 |
| (TTL − SL)/f | 9.45 | (T3 + T4)/f | 3.90 | | |

The lens assembly 2 of the second embodiment is a preferred embodiment when it satisfies conditions (1) to (8) as well as the refractive power and surface shape shown in Table 4.

The lens assembly 2 of the second embodiment can also be modified to satisfy any one of the conditions (1) to (8), the first lens is with negative refractive power, the second lens is with negative refractive power, the third lens is with positive refractive power, the fourth lens is with positive refractive power, the fifth lens is a biconvex lens with positive refractive power and includes a convex surface facing the object side and another convex surface facing the image side, the sixth lens includes a concave surface facing the image side, and the seventh lens is with positive refractive power and includes a convex surface facing the object side. The basic function of the lens assembly 2 of the present invention can be achieved without any additional features or conditions.

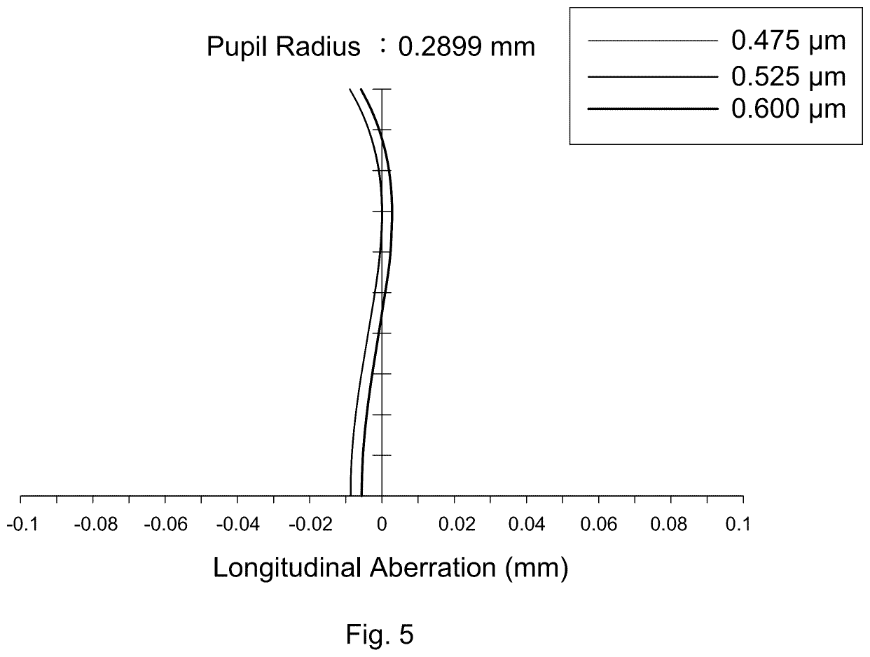

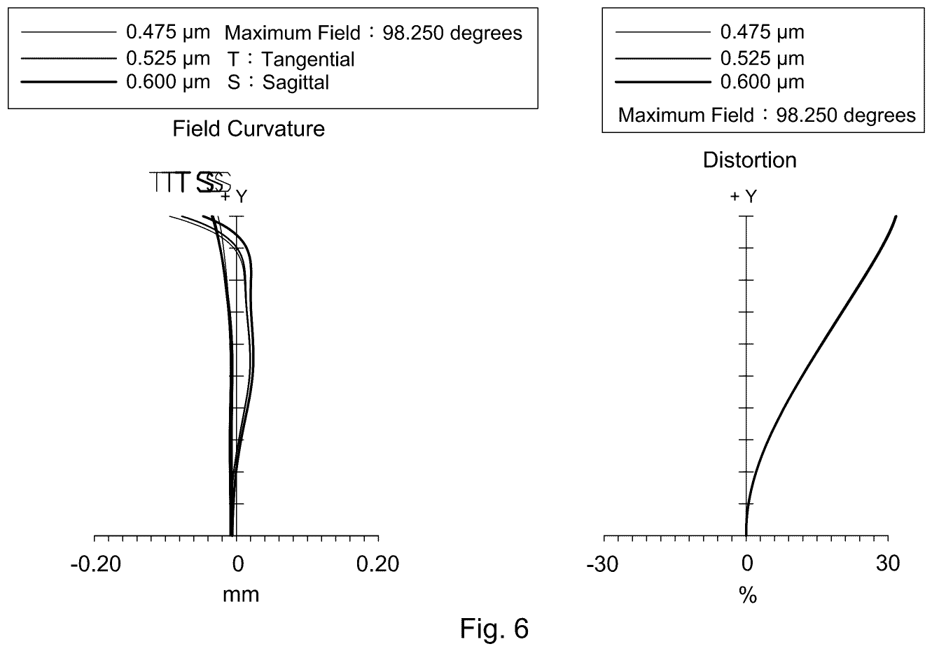

In addition, the lens assembly 2 of the second embodiment can meet the requirements of optical performance as seen in FIGS. 5-6. It can be seen from FIG. 5 that the longitudinal aberration in the lens assembly 2 of the second embodiment ranges from −0.01 mm to 0.005 mm. It can be seen from FIG. 6 that the field curvature of tangential direction and sagittal direction, and the distortion in the lens assembly 2 of the second embodiment ranges from −0.10 mm to 0.03 mm and 0% to 33%. It is obvious that the longitudinal aberration, the field curvature, and the distortion can be corrected effectively for the lens assembly 2 of the second embodiment. Therefore, the lens assembly 2 of the second embodiment is capable of good optical performance.

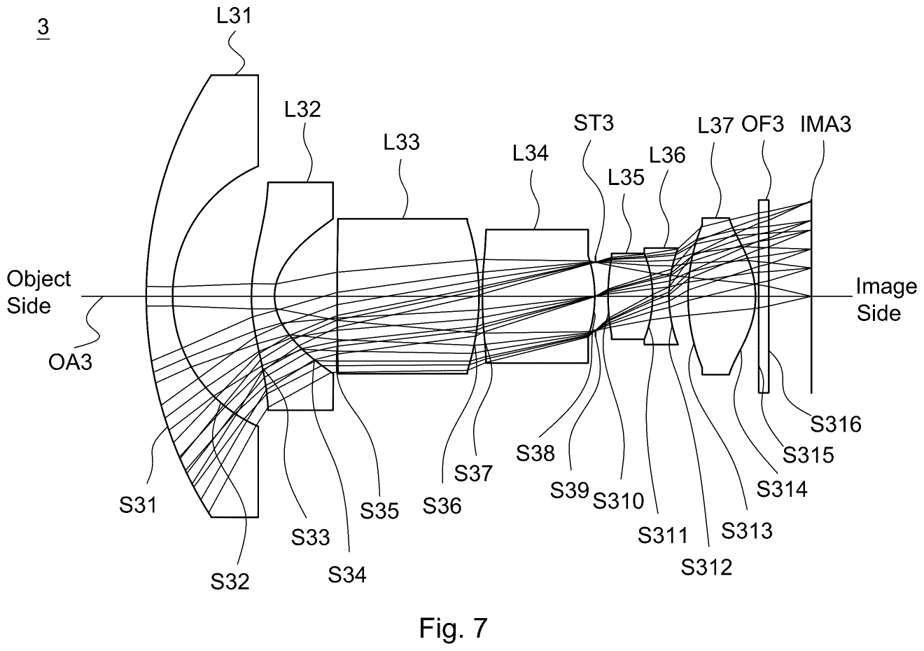

A detailed description of a lens assembly in accordance with a third embodiment of the invention is as follows. Referring to FIG. 7, the lens assembly 3 includes a first lens L31, a second lens L32, a third lens L33, a fourth lens L34, a stop ST3, a fifth lens L35, a sixth lens L36, a seventh lens L37, and an optical filter OF3, all of which are arranged in order from an object side to an image side along an optical axis OA3. In operation, the light from the object side is imaged on an image plane IMA3.

According to the foregoing, wherein: the third lens L33 is a biconvex lens, wherein the object side surface S35 is a convex surface and both of the object side surface S35 and image side surface S36 are spherical surfaces; the fourth lens L34 is a biconvex lens, wherein the object side surface S37 is a convex surface and both of the object side surface S37 and image side surface S38 are aspheric surfaces; both of the object side surface S315 and image side surface S316 of the optical filter OF3 are plane surfaces; with the above design of the lenses, stop ST3, and at least one of the conditions (1)-(8) satisfied, the lens assembly 3 can have an effective increased resolution and an effective corrected aberration.

Table 7 shows the optical specification of the lens assembly 3 in FIG. 7.

TABLE 7
Effective Focal Length = 1.35 mm F-number = 2.20
Total Lens Length = 20.31 mm Full Field of View = 196.70 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S31 | 12.388 | 0.801 | 1.871 | 40.729 | −7.866 | L31 |
| S32 | 4.303 | 2.413 | | | | |
| S33 | 4.964 | 0.706 | 1.854 | 40.579 | −2.871 | L32 |
| S34 | 1.542 | 1.911 | | | | |
| S35 | 104.184 | 4.332 | 2.003 | 28.316 | 6.934 | L33 |
| S36 | −7.403 | 0.100 | | | | |
| S37 | 11.739 | 3.433 | 1.616 | 63.430 | 5.017 | L34 |
| S38 | −3.755 | 0.019 | | | | |
| S39 | ∞ | 0.385 | | | | ST3 |
| S310 | 6.574 | 1.360 | 1.550 | 75.496 | 4.332 | L35 |
| S311 | −3.492 | 0.500 | 1.808 | 22.764 | −2.204 | L36 |
| S312 | 4.003 | 0.575 | | | | |
| S313 | 4.962 | 2.067 | 1.496 | 80.840 | 3.826 | L37 |
| S314 | −2.664 | 0.100 | | | | |
| S315 | ∞ | 0.300 | 1.517 | 64.167 | | OF3 |
| S316 | ∞ | 1.306 | | | | |

The definition of aspheric surface sag z of each aspheric surface in table 7 is the same as that of in Table 1, and is not described here again.

In the third embodiment, the conic constant k and the aspheric coefficients A, B, C of each aspheric surface are shown in Table 8.

TABLE 8

| Surface | | | | |
|---|---|---|---|---|
| Number | k | A | B | C |
| S33 | −5.411313 | −0.003308808 | 6.5766E−05 | 0 |
| S34 | −0.7189806 | −0.007512286 | −0.0006149 | −0.00015869 |
| S37 | 0 | −0.002102852 | −0.0001657 | −4.75674E−05 |
| S38 | 0 | −0.000199808 | 0.00033651 | −0.000239678 |
| S313 | 0.1309221 | −0.010728421 | 0.0025601 | −0.000189014 |
| S314 | −1.023611 | 0.012230713 | −0.0006693 | 0.000381425 |

Table 9 shows the parameters and condition values for conditions (1)-(8) in accordance with the third embodiment of the invention. It can be seen from Table 9 that the lens assembly 3 of the third embodiment satisfies the conditions (1)-(8).

TABLE 9

| T67 | 0.57 mm | SL | 6.59 mm | T3 | 4.33 mm |
|---|---|---|---|---|---|
| T4 | 3.43 mm | Max(f3, f4) | 6.93 mm | | |
| (f1 + f2)/f3 | −1.55 | (f3 + f4)/Max(f3, f4) | 1.72 | T3/f3 + T4/f4 | 1.31 |
| (R51 − R52)/R62 | 2.51 | (R62 × R71)/T67 | 34.57 mm | (f5 + f6)/f7 | 0.56 |
| (TTL − SL)/f | 10.16 | (T3 +T4)/f | 5.75 | | |

The lens assembly 3 of the third embodiment is a preferred embodiment when it satisfies conditions (1) to (8) as well as the refractive power and surface shape shown in Table 7.

The lens assembly 3 of the third embodiment can also be modified to satisfy any one of the conditions (1) to (8), the first lens is with negative refractive power, the second lens is with negative refractive power, the third lens is with positive refractive power, the fourth lens is with positive refractive power, the fifth lens is a biconvex lens with positive refractive power and includes a convex surface facing the object side and another convex surface facing the image side, the sixth lens includes a concave surface facing the image side, and the seventh lens is with positive refractive power and includes a convex surface facing the object side. The basic function of the lens assembly 3 of the present invention can be achieved without any additional features or conditions.

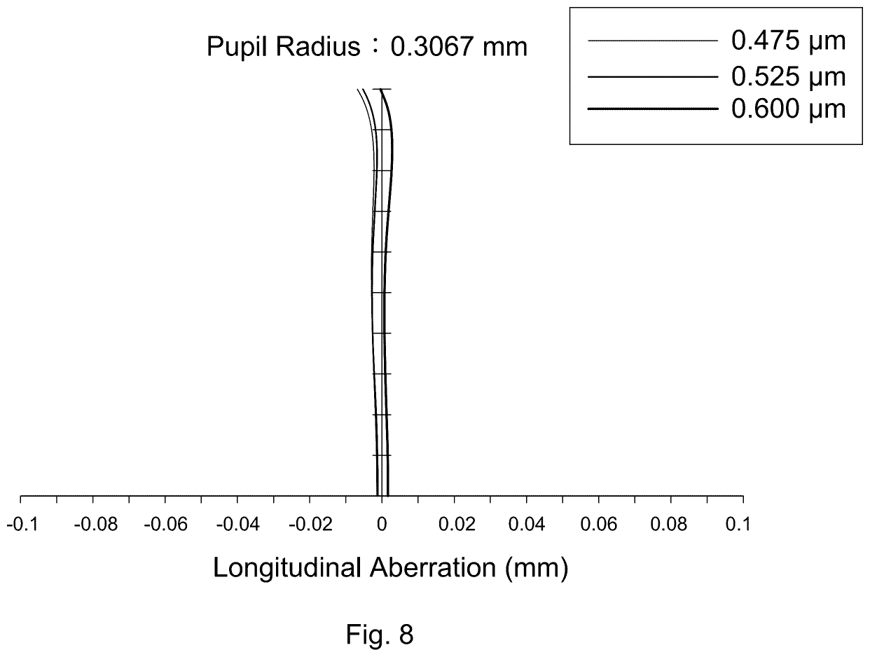

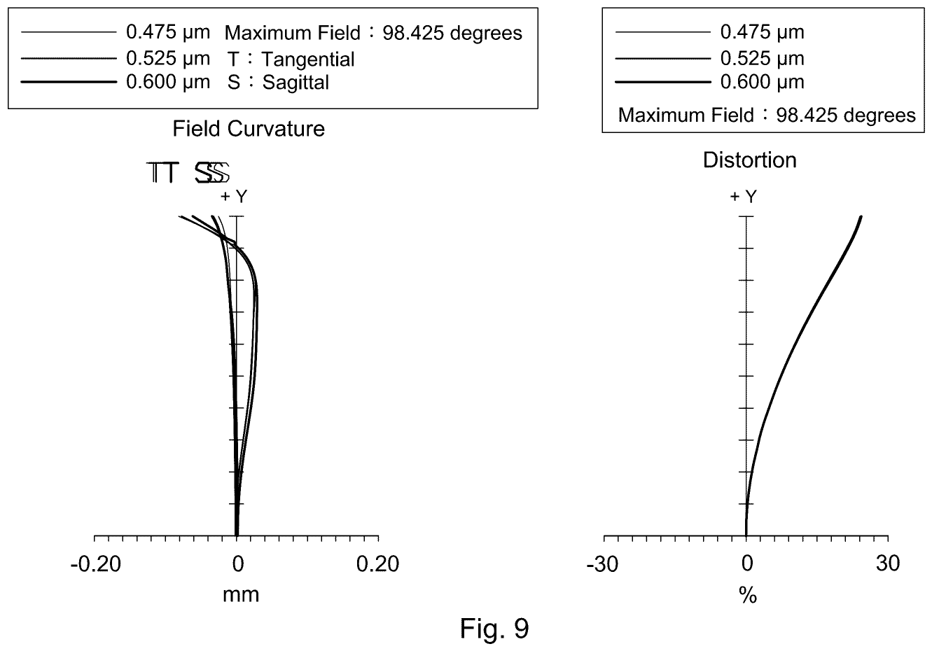

In addition, the lens assembly 3 of the third embodiment can meet the requirements of optical performance as seen in FIGS. 8-9. It can be seen from FIG. 8 that the longitudinal aberration in the lens assembly 3 of the third embodiment ranges from −0.01 mm to 0.005 mm. It can be seen from FIG. 9 that the field curvature of tangential direction and sagittal direction, and the distortion in the lens assembly 3 of the third embodiment ranges from −0.08 mm to 0.04 mm and 0% to 25%. It is obvious that the longitudinal aberration, the field curvature, and the distortion can be corrected effectively for the lens assembly 3 of the third embodiment. Therefore, the lens assembly 3 of the third embodiment is capable of good optical performance.

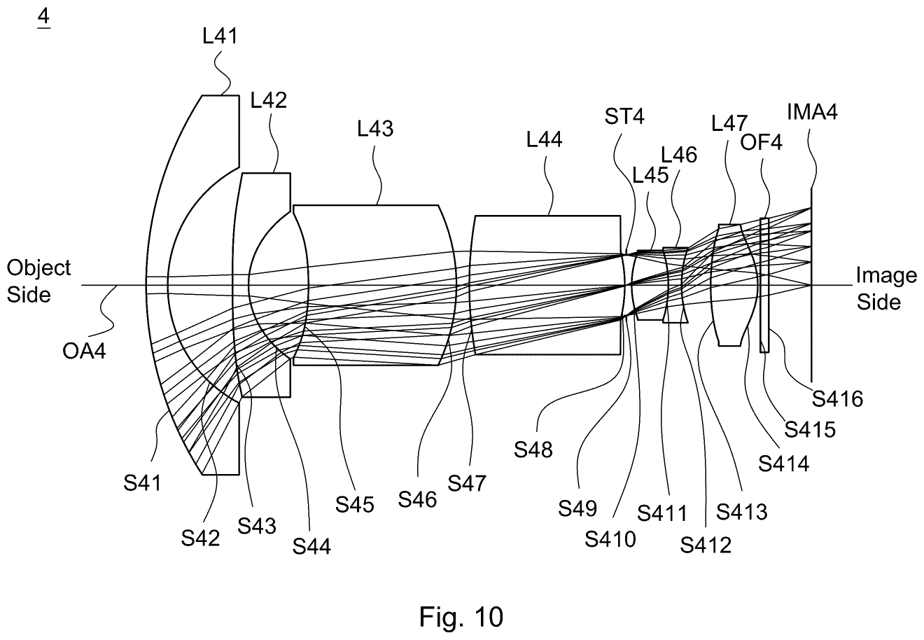

A detailed description of a lens assembly in accordance with a fourth embodiment of the invention is as follows. Referring to FIG. 10, the lens assembly 4 includes a first lens L41, a second lens L42, a third lens L43, a fourth lens L44, a stop ST4, a fifth lens L45, a sixth lens L46, a seventh lens L47, and an optical filter OF4, all of which are arranged in order from an object side to an image side along an optical axis OA4. In operation, the light from the object side is imaged on an image plane IMA4.

According to the foregoing, wherein: the third lens L43 is a meniscus lens, wherein the object side surface S45 is a concave surface and both of the object side surface S45 and image side surface S46 are aspheric surfaces; the fourth lens L44 is a biconvex lens, wherein the object side surface S47 is a convex surface and both of the object side surface S47 and image side surface S48 are spherical surfaces; both of the object side surface S415 and image side surface S416 of the optical filter OF4 are plane surfaces; with the above design of the lenses, stop ST4, and at least one of the conditions (1)-(8) satisfied, the lens assembly 4 can have an effective increased resolution and an effective corrected aberration.

Table 10 shows the optical specification of the lens assembly 4 in FIG. 10.

TABLE 10
Effective Focal Length = 1.41 mm F-number = 2.20
Total Lens Length = 24.82 mm Full Field of View = 195.50 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S41 | 12.984 | 0.800 | 1.835 | 42.721 | −9.911 | L41 |
| S42 | 4.938 | 2.420 | | | | |
| S43 | 45.966 | 0.600 | 1.774 | 49.590 | −4.224 | L42 |
| S44 | 3.057 | 2.238 | | | | |
| S45 | −8.843 | 5.501 | 1.882 | 37.221 | 13.328 | L43 |
| S46 | −6.554 | 0.494 | | | | |
| S47 | 14.747 | 5.791 | 1.744 | 44.786 | 6.345 | L44 |
| S48 | −5.847 | 0.074 | | | | |
| S49 | ∞ | 0.198 | | | | ST4 |
| S410 | 3.636 | 1.372 | 1.459 | 90.195 | 4.477 | L45 |
| S411 | −4.195 | 0.500 | 1.847 | 23.785 | −2.434 | L46 |
| S412 | 4.410 | 1.073 | | | | |
| S413 | 7.584 | 1.760 | 1.497 | 82.506 | 4.235 | L47 |
| S414 | −2.707 | 0.100 | | | | |
| S415 | ∞ | 0.300 | 1.517 | 64.167 | | OF4 |
| S416 | ∞ | 1.601 | | | | |

The definition of aspheric surface sag z of each aspheric surface in table 10 is the same as that of in Table 1, and is not described here again.

In the fourth embodiment, the conic constant k and the aspheric coefficients A, B, C of each aspheric surface are shown in Table 11.

TABLE 11

| Surface | | | | |
|---|---|---|---|---|
| Number | k | A | B | C |
| S43 | 0 | 0.000746897 | −1.0388E−05 | 0 |
| S44 | −0.5581847 | 0.004240852 | −0.0003115 | 2.58E−05 |
| S45 | 0 | −0.000838633 | −0.00051055 | 3.39E−05 |
| S46 | −1.095633 | 8.30475E−05 | −3.9892E−05 | 5.32E−06 |
| S413 | 0 | −0.006352424 | 0.001905778 | −8.56E−05 |
| S414 | 0 | 0.011346479 | 0.000479014 | 0.000312 |

Table 12 shows the parameters and condition values for conditions (1)-(8) in accordance with the fourth embodiment of the invention. It can be seen from Table 12 that the lens assembly 4 of the fourth embodiment satisfies the conditions (1)-(8).

TABLE 12

| T67 | 1.07 mm | SL | 6.91 mm | T3 | 5.50 mm |
|---|---|---|---|---|---|
| T4 | 5.79 mm | Max(f3, f4) | 13.33 mm | | |
| (f1 + f2)/f3 | −1.06 | (f3 + f4)/Max(f3, f4) | 1.48 | T3/f3 + T4/f4 | 1.33 |
| (R51 − R52)/R62 | 1.78 | (R62 × R71)/T67 | 31.17 mm | (f5 + f6)/f7 | 0.48 |
| (TTL − SL)/f | 12.68 | (T3 + T4)/f | 7.99 | | |

The lens assembly 4 of the fourth embodiment is a preferred embodiment when it satisfies conditions (1) to (8) as well as the refractive power and surface shape shown in Table 10.

The lens assembly 4 of the fourth embodiment can also be modified to satisfy any one of the conditions (1) to (8), the first lens is with negative refractive power, the second lens is with negative refractive power, the third lens is with positive refractive power, the fourth lens is with positive refractive power, the fifth lens is a biconvex lens with positive refractive power and includes a convex surface facing the object side and another convex surface facing the image side, the sixth lens includes a 405 concave surface facing the image side, and the seventh lens is with positive refractive power and includes a convex surface facing the object side. The basic function of the lens assembly 4 of the present invention can be achieved without any additional features or conditions.

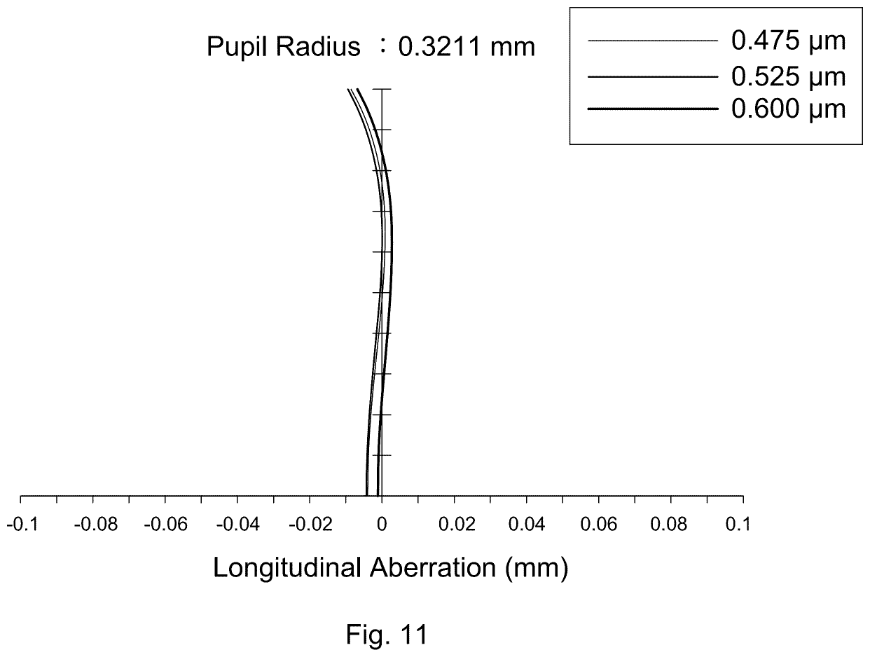

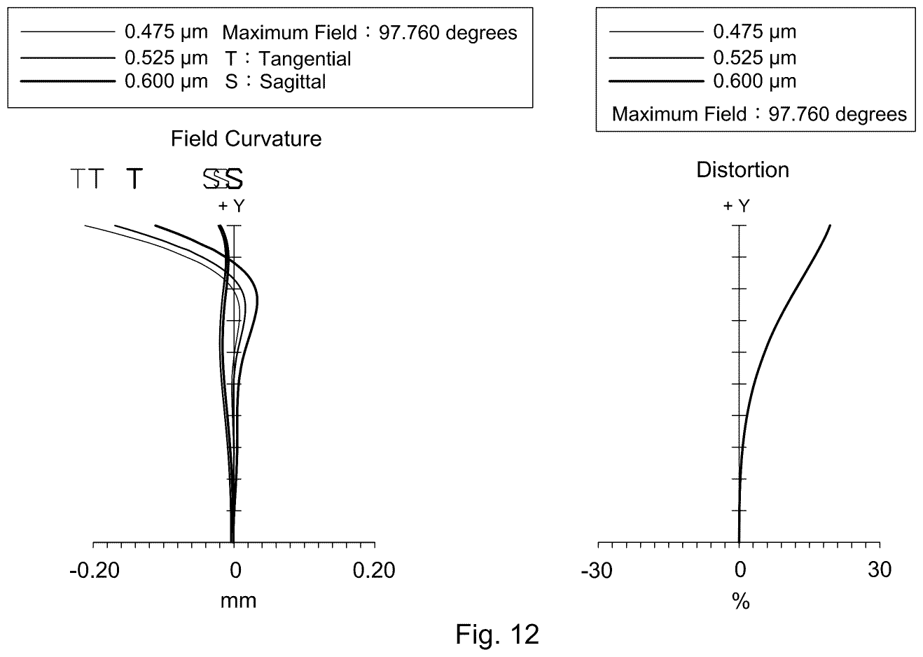

In addition, the lens assembly 4 of the fourth embodiment can meet the requirements of optical performance as seen in FIGS. 11-12. It can be seen from FIG. 11 that the longitudinal aberration in the lens assembly 4 of the fourth embodiment ranges from −0.01 mm to 0.005 mm. It can be seen from FIG. 12 that the field curvature of tangential direction and sagittal direction, and the distortion in the lens assembly 4 of the fourth embodiment ranges from −0.22 mm to 0.04 mm and 0% to 21%. It is obvious that the longitudinal aberration, the field curvature, and the distortion can be corrected effectively for the lens assembly 4 of the fourth embodiment. Therefore, the lens assembly 4 of the fourth embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is with negative refractive power and comprises a convex surface facing an object side and a concave surface facing an image side;
a second lens which is with negative refractive power and comprises a convex surface facing the object side and a concave surface facing the image side;
a third lens which is with refractive power;
a fourth lens which is with positive refractive power;
a fifth lens which is with positive refractive power;
a sixth lens which is with negative refractive power; and
a seventh lens which is a biconvex lens with positive refractive power and comprises a convex surface facing the object side and another convex surface facing the image side;
wherein the first lens, the second lens, the third lens, the fourth lens, the fifth lens, the sixth lens, and the seventh lens are arranged in order from the object side to the image side along an optical axis;
wherein the lens assembly satisfies following condition:
$$0. 4 \leq ( f 5 + f 6 ) / f 7 \leq 0.6 ;$$
wherein f5 is an effective focal length of the fifth lens, f6 is an effective focal length of the sixth lens, and f7 is an effective focal length of the seventh lens.

2. The lens assembly as claimed in claim 1, wherein the third lens is with positive refractive power.

3. The lens assembly as claimed in claim 2, wherein:
the third lens comprises a convex surface facing the image side; and
the fourth lens comprises a convex surface facing the image side.

4. The lens assembly as claimed in claim 3, wherein the third lens further comprises a convex surface or a concave surface facing the object side.

5. The lens assembly as claimed in claim 4, further comprising a stop disposed between the fourth lens and the fifth lens, wherein the lens assembly satisfies at least one of following conditions:
$$- 2 \leq ( f 1 + f 2 ) / f 3 \leq - 1 ;$$
$$1.4 \leq ( f 3 + f 4 ) / Max ( f 3 , f 4 ) \leq 1.9 ;$$
$$0.7 \leq T 3 / f 3 + T 4 / f 4 \leq 1.5 ;$$
$$1.7 \leq ( R 51 - R 52 ) / R 62 \leq 2.1 ;$$
$$30 mm \leq ( R 62 \times R 71 ) / T 67 \leq 40 mm ;$$
$$8 \leq ( TTL - SL ) / f \leq 15 ;$$
$$3 \leq ( T 3 + T 4 ) / f \leq 10 ;$$
wherein f is an effective focal length of the lens assembly, f1 is an effective focal length of the first lens, f2 is an effective focal length of the second lens, f3 is an effective focal length of the third lens, f4 is an effective focal length of the fourth lens, Max(f3,f4) is a greater value among the effective focal length of the third lens and the fourth lens, T3 is an interval from an object side surface of the third lens to an image side surface of the third lens along the optical axis, T4 is an interval from an object side surface of the fourth lens to an image side surface of the fourth lens along the optical axis, R51 is a radius of curvature of an object side surface of the fifth lens, R52 is a radius of curvature of an image side surface of the fifth lens, R62 is a radius of curvature of an image side surface of the sixth lens, R71 is a radius of curvature of an object side surface of the seventh lens, T67 is an air interval from the image side surface of the sixth lens to the object side surface of the seventh lens along the optical axis, TTL is an interval from an object side surface of the first lens to an image plane along the optical axis, and SL is an interval from the stop to the image plane along the optical axis.

6. The lens assembly as claimed in claim 3, wherein the fourth lens further comprise a convex surface or a concave surface facing the object side.

7. The lens assembly as claimed in claim 4, further comprising a stop disposed between the fourth lens and the fifth lens, wherein the lens assembly satisfies at least one of following conditions:
$$- 2 \leq ( f 1 + f 2 ) / f 3 \leq - 1 ;$$
$$1.4 \leq ( f 3 + f 4 ) / Max ( f 3 , f 4 ) \leq 1.9 ;$$
$$0.7 \leq T 3 / f 3 + T 4 / f 4 \leq 1.5 ;$$
$$1.7 \leq ( R 51 - R 52 ) / R 62 \leq 2.1 ;$$
$$30 mm \leq ( R 62 \times R 71 ) / T 67 \leq 40 mm ;$$
$$8 \leq ( TTL - SL ) / f \leq 15 ;$$
$$3 \leq ( T 3 + T 4 ) / f \leq 10 ;$$
wherein f is an effective focal length of the lens assembly, f1 is an effective focal length of the first lens, f2 is an effective focal length of the second lens, f3 is an effective focal length of the third lens, f4 is an effective focal length of the fourth lens, Max(f3,f4) is a greater value among the effective focal length of the third lens and the fourth lens, T3 is an interval from an object side surface of the third lens to an image side surface of the third lens along the optical axis, T4 is an interval from an object side surface of the fourth lens to an image side surface of the fourth lens along the optical axis, R51 is a radius of curvature of an object side surface of the fifth lens, R52 is a radius of curvature of an image side surface of the fifth lens, R62 is a radius of curvature of an image side surface of the sixth lens, R71 is a radius of curvature of an object side surface of the seventh lens, T67 is an air interval from the image side surface of the sixth lens to the object side surface of the seventh lens along the optical axis, TTL is an interval from an object side surface of the first lens to an image plane along the optical axis, and SL is an interval from the stop to the image plane along the optical axis.

8. The lens assembly as claimed in claim 2, wherein the fifth lens is a biconvex lens and comprises a convex surface facing the object side and another convex surface facing the image side.

9. The lens assembly as claimed in claim 8, further comprising a stop disposed between the fourth lens and the fifth lens, wherein the lens assembly satisfies at least one of following conditions:
$$- 2 \leq ( f 1 + f 2 ) / f 3 \leq - 1 ;$$
$$1.4 \leq ( f 3 + f 4 ) / Max ( f 3 , f 4 ) \leq 1.9 ;$$
$$0.7 \leq T 3 / f 3 + T 4 / f 4 \leq 1.5 ;$$
$$1.7 \leq ( R 51 - R 52 ) / R 62 \leq 2.1 ;$$
$$30 mm \leq ( R 62 \times R 71 ) / T 67 \leq 40 mm ;$$
$$8 \leq ( TTL - SL ) / f \leq 15 ;$$
$$3 \leq ( T 3 + T 4 ) / f \leq 10 ;$$
wherein f is an effective focal length of the lens assembly, f1 is an effective focal length of the first lens, f2 is an effective focal length of the second lens, f3 is an effective focal length of the third lens, f4 is an effective focal length of the fourth lens, Max(f3,f4) is a greater value among the effective focal length of the third lens and the fourth lens, T3 is an interval from an object side surface of the third lens to an image side surface of the third lens along the optical axis, T4 is an interval from an object side surface of the fourth lens to an image side surface of the fourth lens along the optical axis, R51 is a radius of curvature of an object side surface of the fifth lens, R52 is a radius of curvature of an image side surface of the fifth lens, R62 is a radius of curvature of an image side surface of the sixth lens, R71 is a radius of curvature of an object side surface of the seventh lens, T67 is an air interval from the image side surface of the sixth lens to the object side surface of the seventh lens along the optical axis, TTL is an interval from an object side surface of the first lens to an image plane along the optical axis, and SL is an interval from the stop to the image plane along the optical axis.

10. The lens assembly as claimed in claim 2, wherein the sixth lens is a biconcave lens and comprises a concave surface facing the object side and another concave surface facing the image side.

11. The lens assembly as claimed in claim 10, further comprising a stop disposed between the fourth lens and the fifth lens, wherein the lens assembly satisfies at least one of following conditions:
$$- 2 \leq ( f 1 + f 2 ) / f 3 \leq - 1 ;$$
$$1.4 \leq ( f 3 + f 4 ) / Max ( f 3 , f 4 ) \leq 1.9 ;$$
$$0.7 \leq T 3 / f 3 + T 4 / f 4 \leq 1.5 ;$$
$$1.7 \leq ( R 51 - R 52 ) / R 62 \leq 2.1 ;$$
$$30 mm \leq ( R 62 \times R 71 ) / T 67 \leq 40 mm ;$$
$$8 \leq ( TTL - SL ) / f \leq 15 ;$$
$$3 \leq ( T 3 + T 4 ) / f \leq 10 ;$$
wherein f is an effective focal length of the lens assembly, f1 is an effective focal length of the first lens, f2 is an effective focal length of the second lens, f3 is an effective focal length of the third lens, f4 is an effective focal length of the fourth lens, Max(f3,f4) is a greater value among the effective focal length of the third lens and the fourth lens, T3 is an interval from an object side surface of the third lens to an image side surface of the third lens along the optical axis, T4 is an interval from an object side surface of the fourth lens to an image side surface of the fourth lens along the optical axis, R51 is a radius of curvature of an object side surface of the fifth lens, R52 is a radius of curvature of an image side surface of the fifth lens, R62 is a radius of curvature of an image side surface of the sixth lens, R71 is a radius of curvature of an object side surface of the seventh lens, T67 is an air interval from the image side surface of the sixth lens to the object side surface of the seventh lens along the optical axis, TTL is an interval from an object side surface of the first lens to an image plane along the optical axis, and SL is an interval from the stop to the image plane along the optical axis.

12. The lens assembly as claimed in claim 1, wherein the fifth lens and the sixth lens are cemented or there is no air gap between the fifth lens and the sixth lens.

13. The lens assembly as claimed in claim 1, further comprising a stop disposed between the fourth lens and the fifth lens.

14. The lens assembly as claimed in claim 1, further comprising a stop disposed between the fourth lens and the fifth lens, wherein the lens assembly satisfies at least one of following conditions:
$$- 2 \leq ( f 1 + f 2 ) / f 3 \leq - 1 ;$$
$$1.4 \leq ( f 3 + f 4 ) / Max ( f 3 , f 4 ) \leq 1.9 ;$$
$$0.7 \leq T 3 / f 3 + T 4 / f 4 \leq 1.5 ;$$
$$1.7 \leq ( R 51 - R 52 ) / R 62 \leq 2.1 ;$$
$$30 mm \leq ( R 62 \times R 71 ) / T 67 \leq 40 mm ;$$
$$8 \leq ( TTL - SL ) / f \leq 15 ;$$
$$3 \leq ( T 3 + T 4 ) / f \leq 10 ;$$
wherein f is an effective focal length of the lens assembly, f1 is an effective focal length of the first lens, f2 is an effective focal length of the second lens, f3 is an effective focal length of the third lens, f4 is an effective focal length of the fourth lens, Max(f3,f4) is a greater value among the effective focal length of the third lens and the fourth lens, T3 is an interval from an object side surface of the third lens to an image side surface of the third lens along the optical axis, T4 is an interval from an object side surface of the fourth lens to an image side surface of the fourth lens along the optical axis, R51 is a radius of curvature of an object side surface of the fifth lens, R52 is a radius of curvature of an image side surface of the fifth lens, R62 is a radius of curvature of an image side surface of the sixth lens, R71 is a radius of curvature of an object side surface of the seventh lens, T67 is an air interval from the image side surface of the sixth lens to the object side surface of the seventh lens along the optical axis, TTL is an interval from an object side surface of the first lens to an image plane along the optical axis, and SL is an interval from the stop to the image plane along the optical axis
